(19) United States
(12) Patent Application Publication
(10) Pub. No.: US 2025/0329317 A1
(43) Pub. Date: Oct. 23, 2025

(54) GENERATING AUDIO-BASED MUSICAL CONTENT AND/OR AUDIO-VISUAL-BASED MUSICAL CONTENT USING GENERATIVE MODEL(S)

(71) Applicant: GOOGLE LLC, Mountain View, CA (US)

(72) Inventors: Ágoston Weisz, Zurich (CH); Kwaku Obeng Akoi, Richardson, TX (US); Michael Andrew Goodman, Oakland, CA (US); Olivier Siegenthaler, Zurich (CH)

(21) Appl. No.: 18/640,681

(22) Filed: Apr. 19, 2024

(51) Int. Cl. G10H 1/00; G06T 11/00

(52) U.S. Cl. CPC G10H 1/0025; G06T 11/00; G10H 2210/111

(57) ABSTRACT

Implementations relate to utilizing generative model(s) (GM(s)) to generate musical content that includes at least lyrical content and music composition content. Processor(s) of a system can: receive user input associated with a client device of a user that includes a request for the musical content, generate the musical content, and cause the musical content to be audibly rendered at the client device. In some implementations, the processor(s) can cause a single GM to process GM input (including at least the user input) to generate GM output and can determine the lyrical content and the music composition content based on the GM output. In other implementations, the processor(s) can cause multiple GMs to process respective GM inputs (each including at least the user input) to generate respective GM outputs and can determine the lyrical content and the music composition content based on the respective GM outputs.

### BACKGROUND

Various generative model(s) (GM(s)) have been proposed that can be used to process user input(s), to generate output that reflects generative content that is responsive to the user input(s). For example, large language models (LLM(s)) have been developed that can be used to process user input(s), to generate LLM output that reflects text-based generative content that is responsive to the user input(s). Further, music generation models have been developed that can be used to process user input(s), to generate music generation output that reflects audio capturing music that is responsive to the user input(s). Moreover, image and video generation model(s) have been developed that can be used to process user input(s), to generate image and/or video generation output that reflects image-based and/or video-based generative content that is responsive to the user input(s).

However, in many instances, a user must interact with various disparate GM(s) to obtain this generative content. For instance, assume that the user wants to generate musical content. In this example, the user may interact with an LLM to generate lyrical content for the musical content and a music generation model for musical composition content. However, the user interacting with these disparate GM(s) typically requires disparate interactions with these disparate GM(s) to obtain the desired musical content, which wastes computational resources by requiring these disparate interactions and also wastes network resources since these disparate GM(s) are typically executed at remote server(s) due to their size. Further, the lyrical content and the musical composition generated by these disparate GM(s) may be nonsensical in that the lyrical content may not objectively match the music composition content such that the lyrical content and the music composition content is unusable, thereby wasting computational and/or network resources during these disparate interactions. Moreover, even if the lyrical content generated using the LLM does objectively match the music composition content generated using the music generation model, additional processing may be required to properly synchronize the lyrical content and the music composition content.

### SUMMARY

Implementations described herein relate to utilizing generative model(s) (GM(s)) to generate audio-based musical content that includes at least lyrical content and music composition content. In some implementations, the audio-based musical content can further include visual multimedia content (e.g., generative or non-generative visual multimedia visual content), resulting in audio-visual-based musical content. Processor(s) of a system can: receive user input associated with a client device of a user that includes a request for the musical content, generate the musical content, and cause the musical content to be rendered at the client device. In some implementations, the processor(s) can cause a single GM to process GM input (including at least the user input) to generate GM output and can determine the lyrical content and the music composition content based on the GM output. In other implementations, the processor(s) can cause multiple GMs to process respective GM inputs (each including at least the user input) to generate respective GM outputs and can determine the lyrical content and the music composition content based on the respective GM outputs. In various implementations, the processor(s) can receive additional user input associated with the client device of the user that includes a request to modify the musical content.

In implementations where the single GM is utilized to process the GM input to generate the GM output, the single GM can be a multimodal GM that is fine-tuned to receive multimodal inputs, such as text-based user input(s), audio-based user input(s), and/or vision-based user input(s), and is fine-tuned to generate multimodal outputs, such as text-based output(s), audio-based output(s), and/or vision-based output(s). Some examples of multimodal GMs that are capable of receiving multimodal inputs and generating multimodal outputs are Bard, Gemini, GPT, etc. Accordingly, in processing the GM input (including the user input and optionally other context(s), prompt(s), etc.) using the single GM, the GM output can include various probability distributions over sequences of tokens. For instance, in determining the lyrical content, the processor(s) can employ various decoding techniques to determine the lyrical content from a sequence of words or word units (e.g., text-based output) or from a sequence of phonemes or phonetic units (e.g., audio-based output) and based on the probability distribution over the sequence of words or word units or over the sequence of phonemes or phonetic units. Further, in determining the lyrical content, the processor(s) can employ various decoding techniques to determine the music composition content from a sequence of musical notes or musical note units and based on the probability distribution over the sequence of musical notes or musical note units.

By utilizing the single GM as described herein to generate the audio-based musical content and/or the audio-visual-based musical content, one or more technical advantages can be achieved. As one non-limiting example, a single unified user interface is utilized to enable the user to provide simplified user inputs to generate the audio-based musical content and/or the audio-visual-based musical content. As a result, the user need not interact with multiple GM(s) to generate the audio-based musical content and/or the audio-visual-based musical content. These techniques are particularly advantageous given the hardware constraints of some client devices. For instance, assume that the client device of the user is a mobile device of a user that has limited display size (e.g., relative to a display of, for example, a laptop or desktop computer). In this instance, the single unified user interface that enables the user to provide the simplified user inputs to generate the audio-based musical content and/or the audio-visual-based musical content without the user having to switch between GM applications, between tabs of a web browser application, etc. to generate the audio-based musical content and/or the audio-visual-based musical content, thereby reducing a quantity of user inputs received at the mobile device and concluding an interaction between the user and the mobile device in a more quick and efficient manner. As another non-limiting example, and as a result of the single GM being fine-tuned to generate the audio-based musical content and/or the audio-visual-based musical content, the need for post-processing of the audio-based musical content and/or the audio-visual-based musical content to ensure synchronization thereof is obviated.

In implementations where the multiple GMs are utilized to process the respective GM inputs to generate the respective GM outputs, each of the multiple GMs can be unimodal GMs and/or multimodal GMs that are jointly fine-tuned to receive respective unimodal or multimodal inputs and are jointly fine-tuned to generate the respective outputs. As noted above, some examples of multimodal GMs that are capable of receiving multimodal inputs and generating multimodal outputs are Bard, Gemini, GPT, etc. Further, one example of a unimodal GM that is capable of receiving unimodal inputs and generating audio-based outputs is AudioLM; some examples of a unimodal GM that is capable of receiving unimodal inputs and generated text-based outputs are PaLM, LaMDA, etc.; and some examples of a unimodal GM that is capable of receiving unimodal inputs and generated vision-based outputs are Imagen, Dall-E, Sora, etc. Accordingly, the respective GM inputs (including the user input and optionally other context(s), prompt(s), etc.) can be tailored to the respective multiple GMs to generate the respective GM outputs, and each of the respective GM outputs can include respective probability distributions over sequences of tokens in the same or similar manner described above.

By utilizing the multiple GMs as described herein to generate the audio-based musical content and/or the audio-visual-based musical content, one or more technical advantages can be achieved. As one non-limiting example, a single unified user interface is utilized to enable the user to provide simplified user inputs to generate the audio-based musical content and/or the audio-visual-based musical content. Even though the multiple GMs are disparate GMs in these implementations, the user only needs to provide a single user input to invoke calls to each of these multiple different GMs, such that the user may not even be aware that multiple GMs are being utilized to generate the audio-based musical content and/or the audio-visual-based musical content. These techniques are particularly advantageous given the hardware constraints of some client devices. For instance, assume that the client device of the user is a mobile device of a user that has limited display size (e.g., relative to a display of, for example, a laptop or desktop computer). In this instance, the single unified user interface that enables the user to provide the simplified user inputs to generate the audio-based musical content and/or the audio-visual-based musical content without the user having to switch between GM applications, between tabs of a web browser application, etc. to generate the audio-based musical content and/or the audio-visual-based musical content, thereby reducing a quantity of user inputs received at the mobile device and concluding an interaction between the user and the mobile device in a more quick and efficient manner. As another non-limiting example, and as a result of the multiple GMs being jointly fine-tuned to generate the audio-based musical content and/or the audio-visual-based musical content, the need for post-processing of the audio-based musical content and/or the audio-visual-based musical content to ensure synchronization thereof is obviated.

In implementations where the additional user input associated with the client device of the user that includes a request to modify the audio-based musical content and/or the audio-visual-based musical content is received, the processor(s) can determine, based on the additional user input and based on the musical content that was previously rendered, seed(s) to be utilized in processing the additional user input. The seed(s) can be a corresponding lower-level representation of the lyrical content and/or the music composition content that was previously rendered. For instance, the corresponding lower-level representation of the lyrical content and/or the music composition content can be a corresponding embedding in a corresponding embedding space. Accordingly, if the additional user input requests that the lyrical content be modified, but that the music composition content remain the same, then in processing the additional user input and the seed(s), the seed(s) will ensure that the lyrical content is modified (e.g., as requested by the user), but that the music composition content will not be modified. Similarly, if the additional user input requests that the music composition content be modified, but that the lyrical content remain the same, then in processing the additional user input and the seed(s), the seed(s) will ensure that the music composition content is modified (e.g., as requested by the user), but that the lyrical content will not be modified. It should be understood that the seed(s) determined by the processor(s) will be based on how the additional user input requests that the musical content be modified.

By utilizing the seed(s) as described herein in modifying the audio-based musical content and/or the audio-visual-based musical content, one or more technical advantages can be achieved. As one non-limiting example, the seed(s) can constrain the extent of how the audio-based musical content and/or the audio-visual-based musical content is modified based on the additional user input. As a result, the seed(s) enable the user to quickly and efficiently modify the audio-based musical content and/or the audio-visual-based musical content without requiring that the user re-prompt these GM(s) with detailed instructions regarding what they liked about the audio-based musical content and/or the audio-visual-based musical content and/or what they did not like about the audio-based musical content and/or the audio-visual-based musical content. As a result, a length of any additional user input that is processed to modify the audio-based musical content and/or the audio-visual-based musical content is reduced since the additional user input and the seed(s) that are determined (which can be a lower-level representation of the musical content) automatically embed this information, thereby conserving computational resources and network resources in modifying the audio-based musical content and/or the audio-visual-based musical content. Further, absent using the seed(s) as described herein in modifying the audio-based musical content and/or the audio-visual-based musical content, any resulting musical content that is subsequently generated may vary greatly from the musical content that was originally rendered for presentation to the user.

In implementations when the lyrical content is audibly rendered, the processor(s) can optionally cause the lyrical content to be audibly rendered in a voice of the user that provided the user input. For example, the lyrical content may correspond to text that is determined based on GM output. Accordingly, in synthesizing audio data that captures the lyrical content, the processor(s) can utilize a voice embedding of the user (e.g., stored in a user profile database or obtained by requesting the user speak a few sentences during the interaction) and/or a set of one or more prosodic properties associated with the user (e.g., stored in the user profile database or obtained by requesting the user speak a few sentences during the interaction) to synthesize the audio data such that it is audibly perceived as being spoken or sung by the user that provided the user input. As another example, the lyrical content may correspond to audio data that is determined based on GM output. Accordingly, rather than synthesizing audio data that captures the lyrical content, the system can adapt the lyrical content using the voice embedding of the user and/or the set of one or more prosodic properties associated with the user such that it is audibly perceived as being spoken or sung by the user that provided the user input.

By causing the lyrical content to be audibly rendered in the voice of the user that provided the user input as described herein, one or more technical advantages can be achieved. As one non-limiting example, the lyrical content may resonate better with the user or an additional user (e.g., a child of the user, a spouse of the user, a friend of the user, etc.). While what resonates with the user that is consuming the lyrical content will depend on the subjective preferences and goals of the user, the resulting lyrical content will be made more objectively and conveniently more relevant to the user's subjective preferences.

In some implementations where the audio-based musical content further includes the visual multimedia content (e.g., resulting in audio-visual-based musical content), the processor(s) can generate generative visual multimedia content (e.g., generative image(s), generative video(s), etc.). In these implementations, the generative visual multimedia content can be generated using the single GM or using a separate image/video generation model. In additional or alternative implementations where the audio-based musical content further includes the visual multimedia content (e.g., resulting in audio-visual-based musical content), the processor(s) can obtain non-generative visual multimedia content (e.g., non-generative image(s), non-generative video(s), etc.). In these implementations, the non-generative visual multimedia content can be obtained from, for example, an image/video search system, a photo/video album of the user that provided the user input, etc.

By including the visual multimedia content as described herein, one or more technical advantages can be achieved. As one non-limiting example, a single unified user interface is utilized to enable the user to provide simplified user inputs to generate the audio-visual-based musical content. Whether the single GM or the multiple GMs are utilized, the user only needs to provide a single user input to cause the audio-visual-based musical content to be generated. These techniques are particularly advantageous given the hardware constraints of some client devices. For instance, assume that the client device of the user is a mobile device of a user that has limited display size (e.g., relative to a display of, for example, a laptop or desktop computer). In this instance, the single unified user interface that enables the user to provide the simplified user inputs to generate the audio-visual-based musical content without the user having to switch between GM applications, between tabs of a web browser application, etc. to generate the audio-visual-based musical content, thereby reducing a quantity of user inputs received at the mobile device and concluding an interaction between the user and the mobile device in a more quick and efficient manner. As another non-limiting example, and as a result of the single GM being fine-tuned and/or the multiple GMs being jointly fine-tuned to generate the audio-visual-based musical content, the need for post-processing of the audio-visual-based musical content to ensure synchronization thereof is obviated. As another non-limiting example, the visual multimedia content may resonate better with the user or an additional user (e.g., a child of the user, a spouse of the user, a friend of the user, etc.). While what resonates with the user that is consuming the visual multimedia content will depend on the subjective preferences and goals of the user, the resulting visual multimedia content will be made more objectively and conveniently more relevant to the user's subjective preferences.

The above description is provided as an overview of some implementations of the present disclosure. Further description of those implementations, and other implementations, are described in more detail below.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts a process flow for utilizing various components from the example environment of FIG. 1, in accordance with various implementations.

FIG. 3 depicts a flowchart illustrating an example method of using a single generative model (GM) to generate musical content, in accordance with various implementations.

FIG. 4 depicts a flowchart illustrating an example method of using multiple generative models (GMs) to generate musical content, in accordance with various implementations.

FIG. 5A, FIG. 5B, FIG. 5C, FIG. 5D, FIG. 5E, and FIG. 5F depict various non-limiting examples of generating musical content, in accordance with various implementations.

FIG. 6 depicts an example architecture of a computing device, in accordance with various implementations.

### DETAILED DESCRIPTION OF THE DRAWINGS

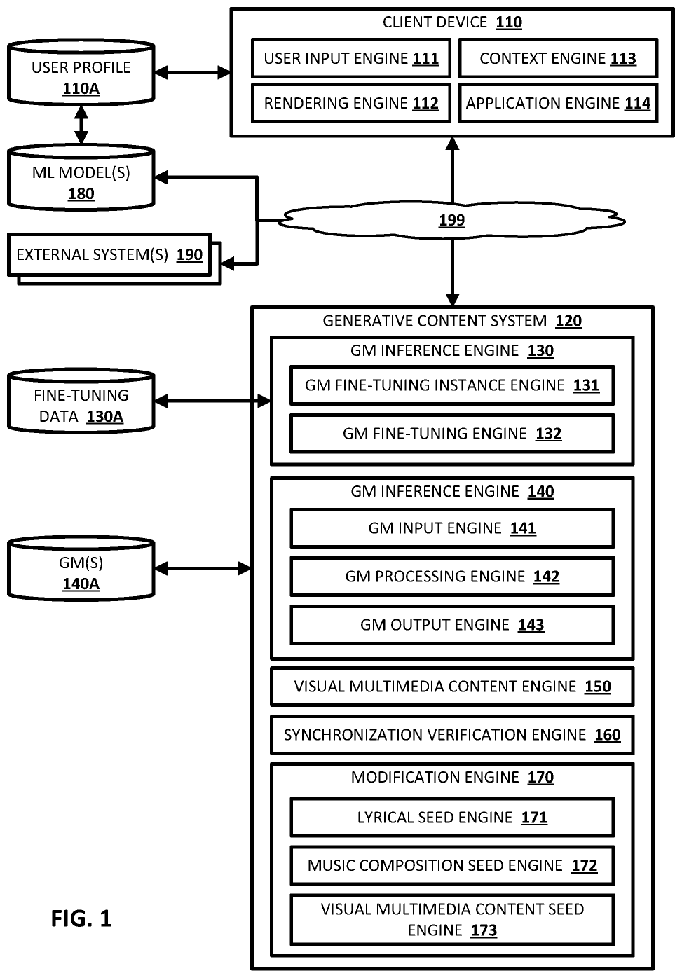

Turning now to FIG. 1, a block diagram of an example environment that demonstrates various aspects of the present disclosure, and in which implementations disclosed herein can be implemented is depicted. The example environment includes a client device 110 and a generative content system 120. In some implementations, all or aspects of the generative content system 120 can be implemented locally at the client device 110. In additional or alternative implementations, all or aspects of the generative content system 120 can be implemented remotely from the client device 110 as depicted in FIG. 1 (e.g., at remote server(s)). In those implementations, the client device 110 and the generative content system 120 can be communicatively coupled with each other via one or more networks 199, such as one or more wired or wireless local area networks (“LANs,” including Wi-Fi®, mesh networks, Bluetooth®, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more software applications, via application engine 114, through which touch inputs and/or other user inputs can be submitted and/or content that is responsive to the touch inputs and/or the other user inputs can be rendered (e.g., audibly and/or visually). The application engine 114 can execute one or more software applications that are separate from an operating system of the client device 110 (e.g., one installed “on top” of the operating system)—or can alternatively be implemented directly by the operating system of the client device 110. For example, the application engine 114 can execute a web browser, generative music creator, or automated assistant installed on top of the operating system of the client device 110. As another example, the application engine 114 can execute a web browser software application, a generative music creator software application, or automated assistant software application that is integrated as part of the operating system of the client device 110. The application engine 114 (and the one or more software applications executed by the application engine 114) can interact with or otherwise provide access to (e.g., as a front-end) the generative content system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to typed and/or touch inputs directed to the client device 110.

In some versions of those implementations, the client device 110 can utilize one or more machine learning (ML) model(s) stored in ML model(s) database 180 to process the user input. For example, the user input received at the client device 110 may be a spoken utterance. In these examples, the user input engine 111 can process, using automatic speech recognition (ASR) model(s) stored in the ML model(s) database 180 (e.g., a recurrent neural network (RNN) model, a transformer model, and/or any other type of ML model capable of performing ASR), audio data that capture the spoken utterance and that is generated by microphone(s) of the client device 110 to generate ASR output. The ASR output can include, for example, speech hypotheses (e.g., term hypotheses and/or transcription hypotheses) that are predicted to correspond to the spoken utterance captured in the audio data, one or more corresponding predicted values (e.g., probabilities, log likelihoods, and/or other values) for each of the speech hypotheses, a plurality of phonemes that are predicted to correspond to the spoken utterance captured in the audio data, one or more corresponding predicted values (e.g., probabilities, log likelihoods, and/or other values) for each of the plurality of phonemes, and/or other ASR output. In these implementations, the user input engine 111 can select one or more of the speech hypotheses as recognized text that corresponds to the spoken utterance (e.g., based on the corresponding predicted values for each of the speech hypotheses), such as when the user input engine 111 utilizes an end-to-end ASR model. In other implementations, the user input engine 111 can select one or more of the predicted phonemes (e.g., based on the corresponding predicted values for each of the predicted phonemes), and determine recognized text that corresponds to the spoken utterance based on the one or more predicted phonemes that are selected, such as when the user input engine 111 utilizes an ASR model that is not end-to-end. In these implementations, the user input engine 111 can optionally employ additional mechanisms (e.g., a directed acyclic graph) to determine the recognized text that corresponds to the spoken utterance based on the one or more predicted phonemes that are selected.

In various implementations, the client device 110 can include a rendering engine 112 that is configured to render content for audible and/or visual presentation to a user of the client device 110 using one or more user interface output devices. For example, the client device 110 can be equipped with speaker(s) that enable the content to be rendered as audible content via the client device 110. Additionally, or alternatively, the client device 110 can be equipped with a display or projector that enables the content to be rendered as textual content, and optionally along with other visual content (e.g., image(s), video(s), etc.), via the client device 110.

In some versions of those implementations, the client device 110 can utilize one or more of the ML model(s) stored in the ML model(s) database 180 to process content described herein. For example, and as noted above, the content can be audibly rendered as audible content via the speaker(s) of the client device 110. In these examples, the rendering engine 112 can process, using text-to-speech (TTS) model(s) stored in the ML model(s) database 180, content (e.g., lyrical content generated using the generative content system 120) to generate synthesized speech audio data that includes computer-generated synthesized speech capturing the lyrical content. In implementations where the rendering engine 112 utilizes the TTS model(s) to process the content, the rendering engine 112 can generate the synthesized speech using a particular set of one or more prosodic properties (e.g., that define a tone, pitch rhythm, speed, etc. of the computer-generated synthesized speech) and/or using a particular voice embedding to reflect different personas and/or speaking styles, such as a particular set of one or more prosodic properties associated with the user of the client device 110 and/or a voice embedding associated with the user of the client device 110.

Notably, although the ML model(s) stored in the ML model(s) database 180 are described above as being implemented locally by the client device 110, it should be understood that is for the sake of example and is not meant to be limiting. For instance, the audio data that captures the spoken utterance can additionally, or alternatively, be streamed to the generative content system 120, and the generative content system 120 can utilize the ASR model(s) stored in the ML model(s) database 180 (or separate cloud-based ASR model(s)) to generate the ASR output. Also, for instance, the summary of the content can be additionally, or alternatively, be processed by the generative content system 120 utilizing the TTS model(s) stored in the ML models) database 180 (or separate cloud-based TTS model(s)) to generate the synthesized speech audio data, and the synthesized speech audio data can be streamed to the client device 110 (or an additional client device of the user) to cause the synthesized speech audio date to audibly rendered for presentation to the user of the client device 110.

In various implementations, the client device 110 can include a context engine 113 that is configured to determine a client device context (e.g., current or recent context) of the client device 110 and/or a user context of a user of the client device 110 (or an active user of the client device 110 when the client device 110 is associated with multiple users). In some of those implementations, the context engine 113 can determine a context based on data stored in user profile database 110A. The data stored in the user profile database 110A can include, for example, user interaction data that characterizes current or recent interaction(s) of the client device 110 and/or a user of the client device 110, location data that characterizes a current or recent location(s) of the client device 110 and/or a geographical region associated with a user of the client device 110, user attribute data that characterizes one or more attributes of a user of the client device 110, user preference data that characterizes one or more preferences of a user of the client device 110, and/or any other data accessible to the context engine 113 via the user profile database 110A or otherwise.

For example, the context engine 113 can determine a current context based on a current state of a dialog session (e.g., considering one or more recent user inputs provided by a user during the dialog session) and/or a current location of the client device 110. For instance, the context engine 113 can determine a current context of “visitor looking for upcoming events in Louisville, Kentucky” based on a recently issued query and an anticipated future location of the client device 110 (e.g., based on recently booked hotel accommodations). As another example, the context engine 113 can determine a current context based on which software application is active in the foreground of the client device 110, a current or recent state of the active software application, and/or content currently or recently rendered by the active software application. A context determined by the context engine 113 can be utilized, for example, in supplementing or rewriting user inputs that are received at the client device 110, in generating an implied user input (e.g., an implied query or prompt formulated independent of any explicit user input provided by a user of the client device 110), and/or in determining to submit an implied user input and/or to render result(s) (e.g., the content) for an implied user input.

Further, the client device 110 and/or the generative content system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household, a workplace, a hotel, etc.).

The generative content system 120 is illustrated in FIG. 1 as including a generative model (GM) training engine 130, a GM inference engine 140, a visual multimedia content engine 150, a synchronization verification engine 160, and a modification engine 170. Some of these engines can be combined and/or omitted in various implementations. Further, these engines can include various sub-engines. For instance, the GM training engine 130 is illustrated in FIG. 1 as including a GM fine-tuning instance engine 131 and a GM fine-tuning engine 132. Further, the GM inference engine 140 is illustrated in FIG. 1 as including a GM input engine 141, a GM processing engine 142, and a GM output engine 143. Moreover, the modification engine 170 is illustrated in FIG. 1 as including a lyrical seed engine 171, a music composition seed engine 172, and a visual multimedia content seed engine 173. Similarly, some of these sub-engines can be combined and/or omitted in various implementations. Accordingly, it should be understood that the various engines and sub-engines of the generative content system 120 illustrated in FIG. 1 are not meant to be limiting.

Further, the generative content system 120 is illustrated in FIG. 1 as interfacing with various databases, such as GM(s) database 120A and fine-tuning data database 130A. Although particular engines and/or sub-engines are depicted as having access to particular databases, it should be understood that is for the sake of example and is not meant to be limiting. For instance, in some implementations, each of the various engines and/or sub-engines of the generative content system 120 may have access to each of the various databases. Further, some of these databases can be combined and/or omitted in various implementations. Accordingly, it should be understood that the various databases interfacing with the generative content system 120 illustrated in FIG. 1 are not meant to be limiting.

Moreover, the generative content system 120 is illustrated in FIG. 1 as interfacing with other system(s), such as external system(s) 190. The external system(s) can include, for example, search system(s) (e.g., text-based search system(s), image-based search system(s), video-based search system(s), etc.) and/or other generative system(s) (other text-based generative system(s), other image-based generative system(s), other video-based generative system(s), other audio-based generative system(s), etc.). In some implementations, the external system(s) 190 are first-party system(s), whereas in other implementations, the external system(s) 190 are third-party system(s). As used herein, the term “first-party” or “first-party entity” refers to an entity that controls, develops, and/or maintains the generative content system 120, whereas the term “third-party” or “third-party entity” refers to an entity that is distinct from the entity that controls, develops, and/or maintains the generative content system 120.

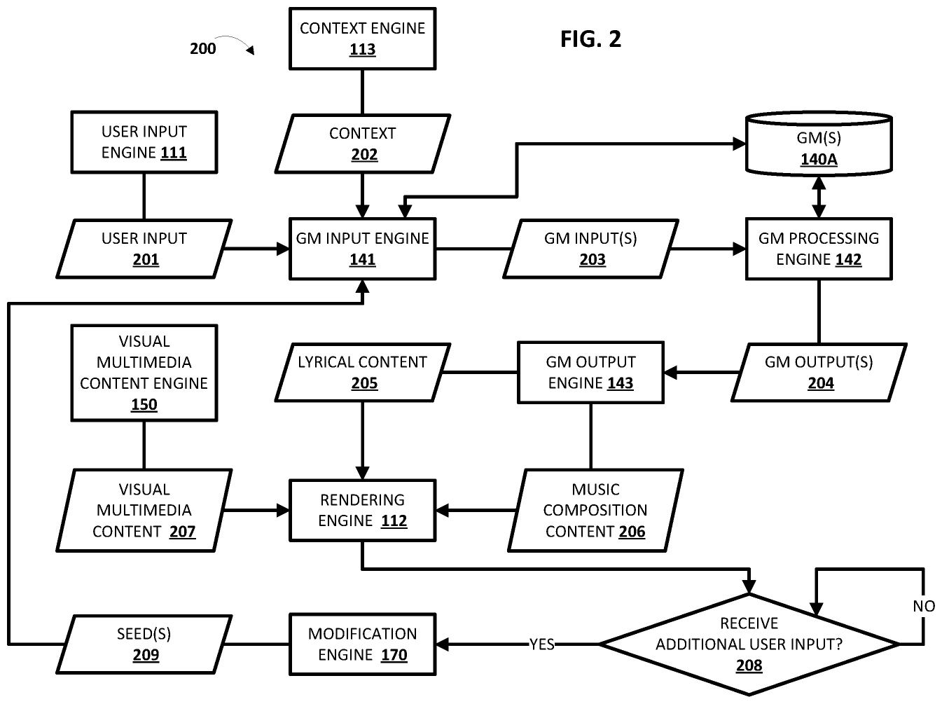

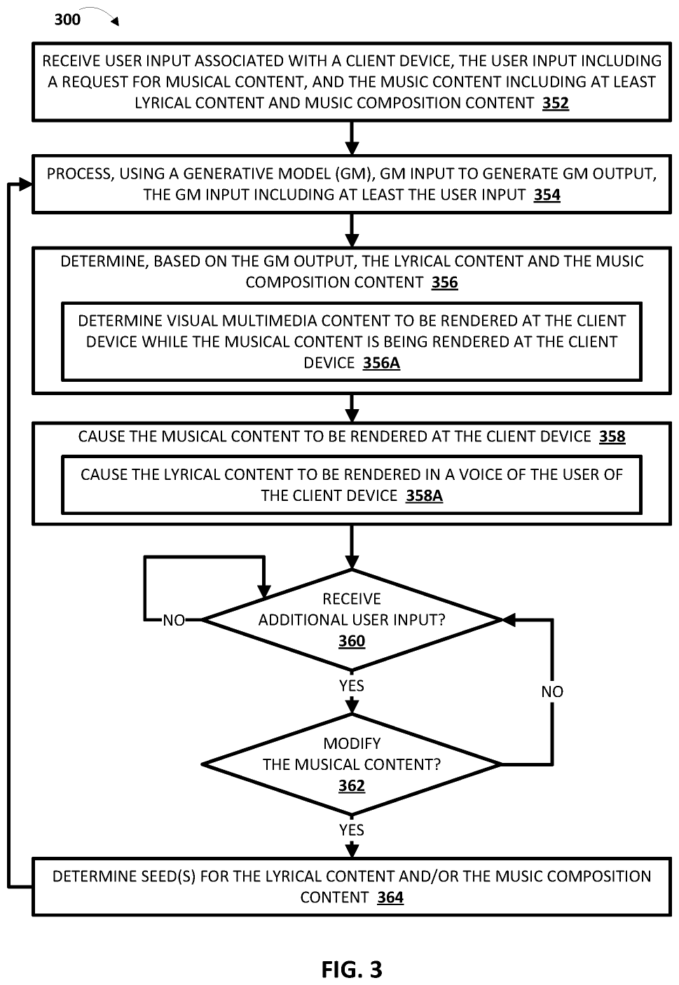

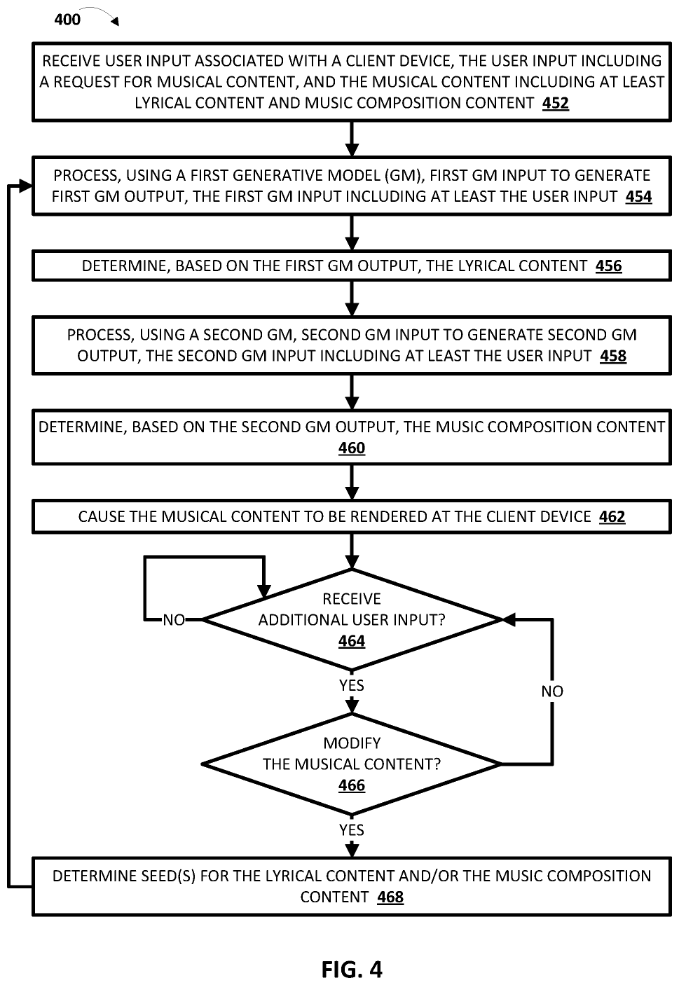

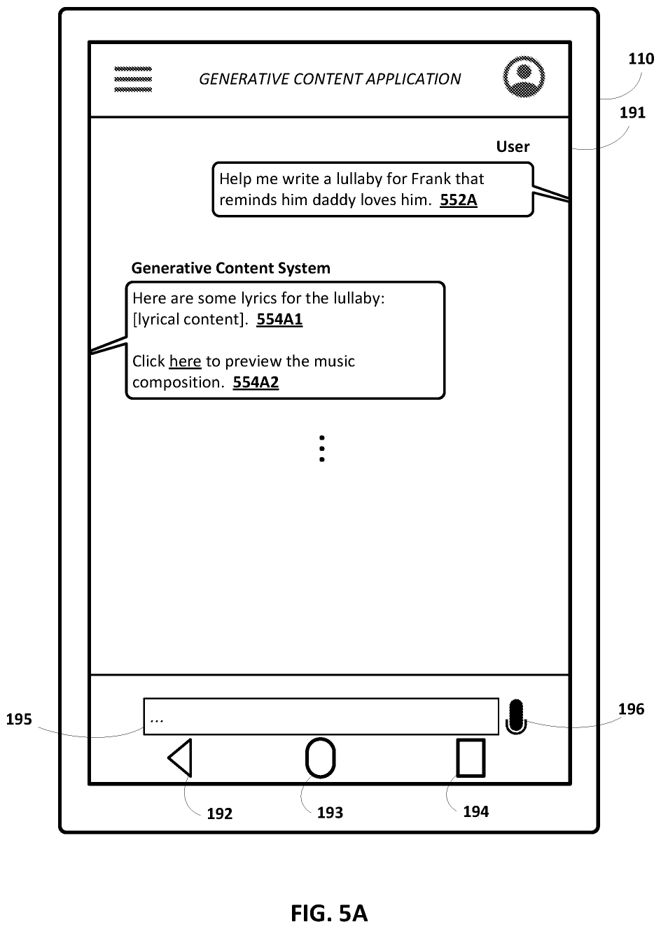

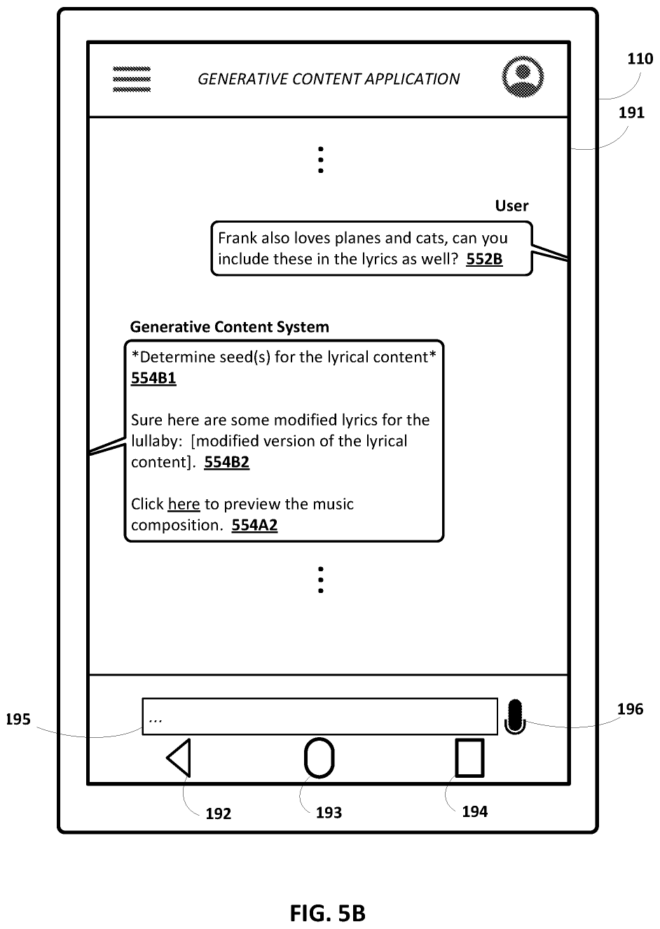

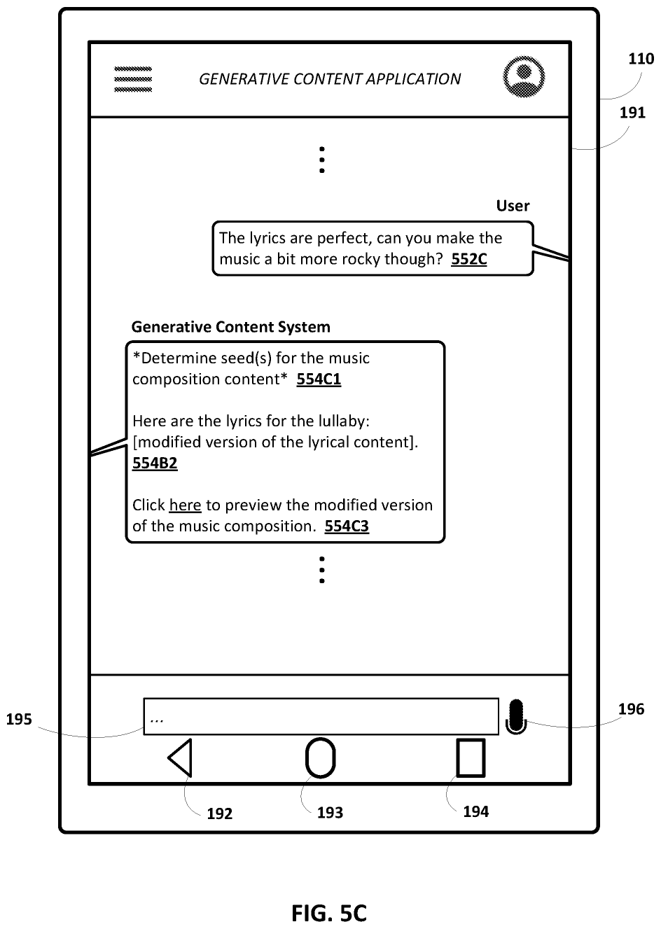

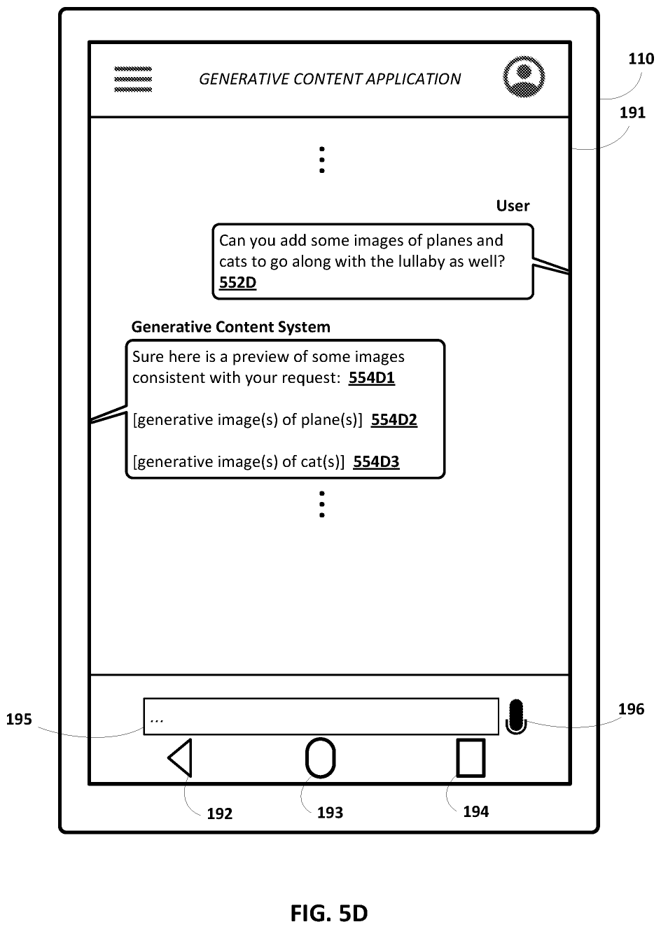

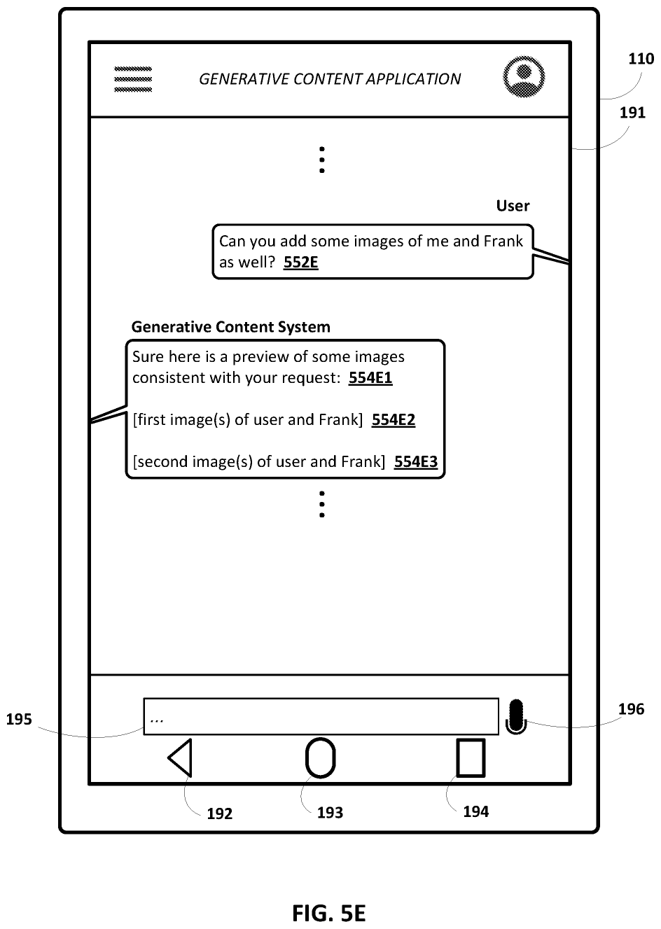

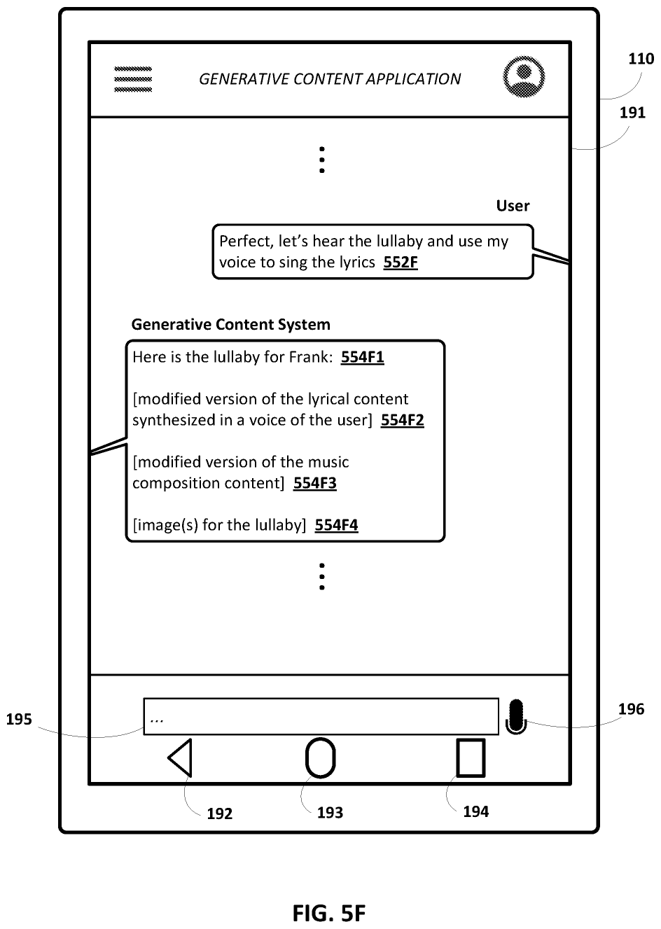

As described in more detail herein (e.g., with respect to FIGS. 2, 3, 4, and 5A-5F), the generative content system 120 can be utilized to generate musical content to be rendered for presentation to a user of the client device 110 and in response to receiving user input that requests the musical content. The musical content can include, for example, lyrical content (e.g., words or phrases for the musical content), music composition content (e.g., musical notes for the musical content or a piece of music performed by one or more instruments), visual multimedia content related to the lyrical content and/or the music composition content (e.g., image(s) and/or video(s)). In some implementations, the musical content can be generated using a single call to a single GM (e.g., as described with respect to FIG. 3). In these implementations, the single GM can be fine-tuned to generate the musical content. In additional or alternative implementations, the musical content can be generated using respective calls to multiple GMs (e.g., as described with respect to FIG. 4). In these implementations, each of the multiple GMs can be jointly fine-tuned in an end-to-end manner to generate respective portions of the musical content. In various implementations, the generative content system 120 can be utilized to refine the musical content to be rendered for presentation to the user of the client device 110 and in response to receiving additional user input(s) that request modification(s) to the musical content (e.g., as described with respect to FIGS. 5A-5F). In these implementations, and in modifying the musical content, the generative content system 120 can determine seed(s) for one or more portions of the musical content that was initially generated based on the user input and utilize the seed(s) and the additional user input for further processing by the GM(s) to generate a modified version of the musical content. By using the seed(s) as described herein, the musical content can be efficiently modified as specified by the additional user input while maintaining certain aspects of the musical content.

As indicated above, in implementations where the musical content is generated using the single call to the single GM, the single GM can be fine-tuned to generate the musical content. The single GM can be stored in the GM model(s) database 120A, and can include any GM (e.g., Bard, Gemini, GPT, and/or any other GM, such as any other GM that is encoder-only based, decoder-only based, sequence-to-sequence based and that optionally includes an attention mechanism or other memory). Notably, the GM(s) stored in the GM(s) database 120A can include billions of weights and/or parameters that are learned through initially training the GM on enormous amounts of diverse data. This enables these GM(s) to generate GM output as a probability distribution over a sequence of tokens as described herein. Further, in implementations where the musical content is generated using the single call to the single GM, the single GM can be a multimodal GM that is fine-tuned to be capable of processing text-based user inputs (e.g., typed user inputs provided by the user of the client device 110), audio-based user inputs (e.g., spoken user inputs provided by the user of the client device 110), and/or vision-based user inputs (e.g., image(s) and/or video(s) provided by the user of the client device 110) to generate text-based content (e.g., text corresponding to the lyrical content as described herein and/or text corresponding to the music composition content, such as music notes, as described herein), audio-based content (e.g., audio data corresponding to the lyrical content as described herein and/or audio data corresponding to the music composition content described herein), and/or visual-based content (e.g., image(s) and/or video(s) associated with the music content as described herein). Further, by virtue of fine-tuning the single GM to generate the musical content, any resulting musical content is synchronized without requiring any additional post-processing of the musical content.

However, in various implementations, the synchronization verification engine 160 can be utilized to verify that the musical content is, in fact, synchronized when played back for presentation to the user of the client device 110. For example, the synchronization verification engine 160 can simulate playback of the musical content, without the musical content being rendered for presentation to the user. During the simulated playback of the musical content, the synchronization verification engine 160 can verify that, for example, that the lyrical content 205 is logically arranged with respect to playback of the music composition content 206, and correct any potential errors by inserting delays for the lyrical content 205, removing delays for the lyrical content 206, adjusting a rhythm or tempo for playback of the lyrical content 205, etc. In some versions of those implementations, the synchronization verification engine 160 can speed up playback of the lyrical content 205 and the music composition content 206 to reduce latency in causing the musical content to be rendered for presentation to the user.

In fine-tuning the single GM, the GM fine-tuning instance engine 131 can access the fine-tuning data database 130A to obtain a plurality of fine-tuning instances. Each of the plurality of fine-tuning instances can include a corresponding fine-tuning user input, corresponding fine-tuning lyrical content, and corresponding fine-tuning music composition content (and optionally corresponding fine-tuning visual multimedia content). Further, in fine-tuning the single GM based on a given fine-tuning instance, of the plurality of fine-tuning instances, the GM fine-tuning engine 132 can process the corresponding user input to generate predicted lyrical content and predicted music composition content (and optionally predicted visual multimedia content). In some implementations, the GM fine-tuning engine 132 can compare the predicted lyrical content to the corresponding fine-tuning lyrical content for the given fine-tuning instance and the predicted music composition content to the corresponding fine-tuning music composition content for the given fine-tuning instance to generate one or more losses (and optionally can compare the predicted visual multimedia content to the corresponding fine-tuning visual multimedia content for the given fine-tuning instance). Moreover, the GM fine-tuning engine 132 can update the single GM based on one or more of the losses. Although particular learning techniques for fine-tuning the single GM are described above (e.g., supervised fine-tuning (SFT) techniques) it should be understood that is for the sake of example and is not meant to be limiting.

For instance, the GM fine-tuning engine 132 can additionally, or alternatively, utilize a reinforcement learning from human feedback (RLHF) technique where the predicted lyrical content and the predicted music composition content (and optionally the predicted visual multimedia content) is provided for presentation to a developer associated with the generative content system 120 and the developer can be feedback with respect to the predicted lyrical content and the predicted music composition content given the corresponding fine-tuning user input that was processed using the single GM. However, it should be noted that techniques that require involvement of the developer (or other users, such as Mechanical Turks) consume additional computational and pecuniary resources.

Also, for instance, the GM fine-tuning instance engine 131 can access fine-tuning data database 130A to obtain a plurality of first fine-tuning instances and a plurality of second fine-tuning instances. Each of the plurality of first fine-tuning instances can include a corresponding fine-tuning user input and corresponding fine-tuning lyrical content, and each of the plurality of second fine-tuning instances can include the corresponding fine-tuning user input and corresponding fine-tuning music composition content. Accordingly, in this instance, for each of the plurality of first fine-tuning instances that includes the corresponding fine-tuning lyrical content, there is a corresponding one of the plurality of second fine-tuning instances that includes the corresponding fine-tuning music composition content for the corresponding fine-tuning lyrical content. The GM fine-tuning engine 132 can process the corresponding user input to generate the predicted lyrical content and the predicted music composition content in the same or similar manner described above.

As also indicated above, in implementations where the musical content is generated using the respective calls to the multiple GMs, each of the multiple GMs can be jointly fine-tuned in an end-to-end manner to generate the respective portions of the musical content. Each of the multiple GMs can be stored in the GM model(s) database 120A, and can include any GM (e.g., Bard, Gemini, GPT, and/or any other GM, such as any other GM that is encoder-only based, decoder-only based, sequence-to-sequence based and that optionally includes an attention mechanism or other memory). Further, in implementations where the musical content is generated using the respective calls to the multiple GMs, each of the GMs may have respective modalities. For instance, a first GM can be fine-tuned to be capable of processing text-based user inputs (e.g., typed user inputs provided by the user of the client device 110), audio-based user inputs (e.g., spoken user inputs provided by the user of the client device 110), and/or vision-based user inputs (e.g., image(s) and/or video(s) provided by the user of the client device 110) to generate text-based content (e.g., text corresponding to the lyrical content as described herein and/or text corresponding to the music composition content, such as music notes, as described herein). Further, a second GM can be fine-tuned to be capable of processing the text-based user inputs, the audio-based user inputs, and/or the vision-based user inputs to generate audio-based content (e.g., audio data corresponding to the lyrical content as described herein and/or audio data corresponding to the music composition content described herein). Moreover, a third GM can be fine-tuned to be capable of processing the text-based user inputs, the audio-based user inputs, and/or the vision-based user inputs to generate visual-based content (e.g., image(s) and/or video(s) associated with the music content as described herein). Further, by virtue of jointly fine-tuning these multiple GMs in an end-to-end manner to generate the musical content, any resulting musical content is synchronized without requiring any additional post-processing of the musical content. However, the synchronization verification engine 160 can be utilized to verify that the musical content is, in fact, synchronized as described above.

In jointly fine-tuning the multiple GMs in an end-to-end manner, the GM fine-tuning instance engine 131 can access the fine-tuning data database 130A to obtain a plurality of respective fine-tuning instances for each of the multiple GMs. For instance, each of a plurality of first fine-tuning instances to be utilized in fine-tuning a first GM to generate the lyrical content can include a corresponding fine-tuning user input and corresponding fine-tuning lyrical content. Further, each of a plurality of second fine-tuning instances to be utilized in fine-tuning a second GM to generate the music composition content can include the corresponding fine-tuning user input and corresponding fine-tuning music composition content. Moreover, each of a plurality of third fine-tuning instances to be utilized in fine-tuning a third GM to generate the visual multimedia content associated with the musical content can include the corresponding fine-tuning user input and corresponding fine-tuning visual multimedia content. Accordingly, in this instance, for each of the plurality of first fine-tuning instances that includes the corresponding fine-tuning lyrical content, there is a corresponding one of the plurality of second fine-tuning instances that includes the corresponding fine-tuning music composition content for the corresponding fine-tuning lyrical content and there is a corresponding one of the plurality of third fine-tuning instances that includes the corresponding fine-tuning visual multimedia content for the corresponding fine-tuning lyrical content and the corresponding fine-tuning music composition content. The GM fine-tuning engine 132 can cause each of the multiple GMs to process the corresponding user input to generate the predicted lyrical content, the predicted music composition content, and the predicted visual multimedia content, respectively, in the same or similar manner described above. However, in jointly fine-tuning the multiple GMs in an end-to-end manner, one or more of the losses can be shared across the multiple GMs, thereby ensuring that the musical content generated using the multiple GMs is synchronized when played back for presentation to the user of the client device 110. However, the synchronization verification engine 160 can be utilized to verify that the musical content is, in fact, synchronized when played back for presentation to the user of the client device 110 as described above.

Turning now to FIG. 2, a process flow for utilizing various components from the example environment of FIG. 1 is depicted. For the sake of example, assume that the user of the client device 110 provides user input 201 and the user input 201 is detected via the user input engine 111. For instance, assume that the user input 201 is “write me a song about patent law”. In this example, the GM input engine 141 can process the user input 201 to generate GM input(s) 203. Notably, in generating the GM input(s) 203, the GM input engine 141 can utilize an explicitation GM (e.g., stored in the GM(s) database 140A). The explicitation GM can be one form of a GM that processes the user input 201 (and optionally context 202 determined by the context engine 113 of the client device 110) to generate the GM input(s) 203. The GM input(s) 203 can then be provided to the GM processing engine 142 to generate GM output(s) 204. Put another way, the GM input engine 141 can utilize explicitation GM to process the raw user input 201 and put it in a structured form that is more suitable for processing by the GM processing engine 142. Further, the GM input engine 141 can utilize explicitation GM to incorporate the context 202 into the GM input(s) and optionally any other dynamic prompts to aid the GM processing engine 142 in generating the GM output(s) 204. For instance, and based on the user input 201 being “write me a song about patent law”, the context 202 can include recent news about patent law or search results for patent news (e.g., obtained via a call to one of the external system(s) 190, such as the Internet), an indication that the user's profession is “patent attorney” based on user profile data stored in the user profile database 110A, and/or other context. Further, and based on the user input 201 being “write me a song about patent law”, a dynamic prompt can include, for instance, “write a song about patent law for a patent attorney, be specific in the lyrics and mention pertinent statutes and regulations for patent law” or the like.

In implementations where a single GM is utilized to generate the musical content, the GM input(s) 203 may only include a single GM input. Further, in these implementations, the GM processing engine 142 can process, using the single GM, the GM input(s) 203 to generate the GM output(s) 204. Moreover, in these implementations, the GM output(s) 204 may include probability distributions over sequences of tokens. For example, in determining lyrical content 205, the GM output engine 143 can employ various decoding techniques to determine the lyrical content 205 from a sequence of words or word units (e.g., text-based output) or from a sequence of phonemes or phonetic units (e.g., audio-based output) and based on the probability distribution over the sequence of words or word units or over the sequence of phonemes or phonetic units. Further, in determining music composition content 206, the GM output engine 143 can employ various decoding techniques to determine the music composition content 206 from a sequence of musical notes or musical note units and based on the probability distribution over the sequence of musical notes or musical note units.

In implementations where multiple GMs are utilized to generate the musical content, the GM input(s) 203 may include a respective GM input for each of the multiple GMs, where each of the respective GM inputs may vary in that the context 202 or dynamic prompt(s) may vary for each of the GMs. Further, in these implementations, the GM processing engine 142 can process, using each of the multiple GMs, the respective one of the GM input(s) 203 to generate the GM output(s) 204. Moreover, in these implementations, the GM output(s) 204 may include respective probability distributions over respective sequences of tokens. For example, in determining lyrical content 205, the GM output engine 143 can employ various decoding techniques to determine the lyrical content 205 from a sequence of words or word units (e.g., text-based output) or from a sequence of phonemes or phonetic units (e.g., audio-based output) and based on the probability distribution over the sequence of words or word units or over the sequence of phonemes or phonetic units. Notably, the probability distribution over the sequence of words or word units or over the sequence of phonemes or phonetic units can be determined using a first GM. Further, in determining music composition content 206, the GM output engine 143 can employ various decoding techniques to determine the music composition content 206 from a sequence of musical notes or musical note units and based on the probability distribution over the sequence of musical notes or musical note units. Notably, the probability distribution over the sequence of musical notes or musical note units can be determined using a second GM that differs from the first GM.

Further, the rendering engine 112 can cause the lyrical content 205 and/or the music composition content 206 to be rendered at the client device 110 of the user as the musical content and responsive to the user input 201. In various implementations, the visual multimedia content engine 150 can determine visual multimedia content 207 to be rendered along with the musical content. In some versions of those implementations, the visual multimedia content 207 can be generative visual multimedia content (e.g., generative image(s), generative video(s), generative animation(s) or gif(s), etc.). In implementations where the single GM is utilized to generate the musical content, the visual multimedia content engine 150 can determine the visual multimedia content 207 based on the GM output(s). In implementations where multiple GMs are utilized to generate the musical content, a separate image generation GM can be utilized to generate the visual multimedia content 207. In other versions of those implementations, the visual multimedia content 207 can be non-generative visual multimedia content (e.g., non-generative image(s), non-generative video(s), non-generative animation(s) or gif(s), etc.). In these implementations, the visual multimedia content engine 150 is non-generative visual multimedia content, the visual multimedia content engine 150 can obtain the non-generative visual multimedia content from one or more database (e.g., an image/video album of the user of the client device 110, an image/video of the user of the client device 110 obtained via a call to one of the external system(s) 190, such as the Internet, etc.).

In various implementations, and as indicated at block 208, the generative content system 120 can receive additional user input to modify the musical content that was originally rendered for presentation to the user. If no additional user input is received, then the generative content system 120 may wait for additional user input to be received at block 208. However, if additional user input is received, then the modification engine 170 can determine seed(s) 209 to be utilized in generating a modified version of the musical content. Continuing with the above example where the user input 201 is “write me a song about patent law”, further assume that the user of the client device 110 provides additional user input of “the lyrics sound great, can you include some additional lyrics about the current state of 103 and obviousness rationales”. In this example, the additional user input indicates that the user of the client device 110 is satisfied with the lyrical content 205 and the music composition content 206 that was originally rendered but indicates a desire to add additional lyrics.

Accordingly, in this example, the modification engine 170 (and more specifically the lyrical seed engine 171) can determine a seed for the lyrical content 205 and the modification engine 170 (and more specifically the music composition seed engine 173) can determine a seed for the music composition content 206. In implementations where the visual multimedia content 207 is included and includes generative visual multimedia content, the modification engine 170 (and more specifically the visual multimedia content seed engine 173) can determine a seed for the visual multimedia content 207. The seed(s) 209 can be a corresponding lower-level representation of the lyrical content 205 and/or the music composition content 206. For instance, the corresponding lower-level representation of the lyrical content and/or the music composition content can be a corresponding embedding in a corresponding embedding space. Thus, the GM input engine 141 can cause the explicitation GM to include the seed(s) in processing of additional GM input(s) to generate a modified version of the lyrical content 205 to include the additional detail about “the current state of 103 and obviousness rationales” as requested by the user via the additional user input. Further, the rendering engine 112 can cause the modified version of the lyrical content 205 and/or the music composition content 206 to be rendered at the client device 110 of the user as the musical content and responsive to the additional user input. The user can continue interacting with the generative content system 120 in this manner to continue modifying the musical content. Optionally, the user of the client device 110 can be provided with one or more selectable elements to share the musical content that is generated via the generative content system 120.

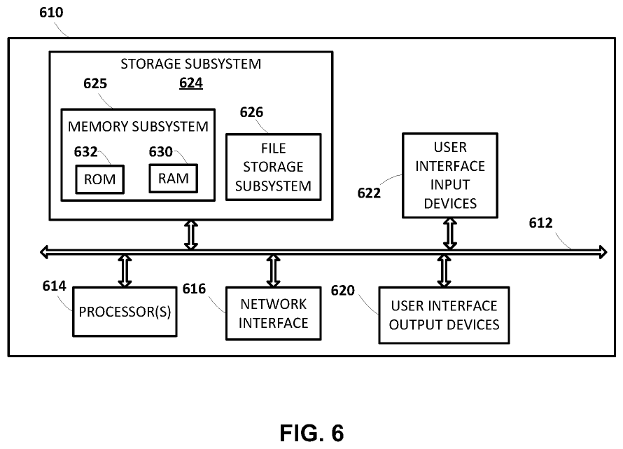

Turning now to FIG. 3, a flowchart illustrating an example method 300 of using a single generative model (GM) to generate musical content is depicted. For convenience, the operations of the method 300 are described with reference to a system that performs the operations. This system of the method 300 includes one or more processors, memory, and/or other component(s) of computing device(s) (e.g., client device 110 of FIG. 1, generative content system 120 of FIG. 1, computing device 610 of FIG. 6, one or more servers, and/or other computing devices). Moreover, while operations of the method 300 are shown in a particular order, this is not meant to be limiting. One or more operations may be reordered, omitted, and/or added.

At block 352, the system receives user input associated with a client device, the user input including a request for musical content, and the musical content including at least lyrical content and music composition content. The user input can be received via typed input, spoken input, touch input, etc.

At block 354, the system processes, using a generative model (GM), GM input to generate GM output, the GM input including at least the user input. For example, the system can generate the GM input (e.g., as described with respect to the GM input processing engine 141 of FIGS. 1 and 2), and can process the GM input, using the GM, to generate the GM output (e.g., as described with respect to the GM processing engine 142 of FIGS. 1 and 2).

At block 356, the system determines, based on the GM output, the lyrical content and the music composition content. For example, the system can determine the lyrical content and the music composition content based on one or more probability distributions over one or more sequences of tokens (e.g., as described with respect to the GM output engine 143 of FIGS. 1 and 2). In some implementations, block 356 may further include sub-block 356A. In these implementations, at sub-block 356A, the system determines visual multimedia content to be rendered at the client device while the musical content is being rendered at the client device. The visual multimedia content can include, for example, generative visual multimedia content and/or non-generative visual multimedia content. In implementations where the visual multimedia content includes generative visual multimedia content, the system can determine the generative visual multimedia content based on one or more of the probability distributions over one or more of the sequences of tokens (e.g., as described with respect to the GM output engine 143 of FIGS. 1 and 2). In additional or alternative implementations, where the visual multimedia content includes generative visual multimedia content, the system can utilize a separate image generation GM or a separate video generation GM that is separate from the GM utilized to process the GM input. In implementations where the visual multimedia content includes non-generative visual multimedia content, the system can obtain the non-generative visual multimedia content from one or more databases that are personal to the user that provided the user input and based on one or more entities referenced in the user input.

At block 358, the system causes the musical content to be rendered at the client device. In some implementations, the system can cause the lyrical content to be visually rendered at a display of the client device. In additional or alternative implementations, the system can cause the lyrical content to be audibly rendered via speaker(s) of the client device. In some implementations, the system can cause the music composition content to be audibly rendered via the speaker(s) of the client device, and optionally along with the lyrical content. In additional or alternative implementations, the system can cause a selectable element or link to be rendered via a display of the client device and that, when selected, causes the music composition content to be audibly rendered via the speaker(s) of the client device.

In some implementations, block 358 may further include sub-block 358A. In these implementations, at sub-block 358A, the system causes the lyrical content to be rendered in a voice of the user of the client device. For example, the lyrical content may correspond to text that is determined based on the GM output. Accordingly, in synthesizing audio data that captures the lyrical content, the system can utilize a voice embedding of the user (e.g., stored in the user profile database 110A or obtained by requesting the user speak a few sentences during the interaction) and/or a set of one or more prosodic properties associated with the user (e.g., stored in the user profile database 110A or obtained by requesting the user speak a few sentences during the interaction) to synthesize the audio data such that it is audibly perceived as being spoken or sung by the user that provided the user input. As another example, the lyrical content may correspond to audio data that is determined based on the GM output. Accordingly, rather than synthesizing audio data that captures the lyrical content, the system can adapt the lyrical content using the voice embedding of the user and/or the set of one or more prosodic properties associated with the user such that it is audibly perceived as being spoken or sung by the user that provided the user input.

At block 360, the system determines whether additional user input has been received. The additional user input can be received via typed input, spoken input, touch input, etc. If, at an iteration of block 360, the system determines that no additional user input has been received, then the system can continue monitoring for additional user input at block 360.

If, at an iteration of block 360, the system determines that additional user input has been received, then the system proceeds to block 362. At block 362, the system determines whether the additional user input was provided to modify the musical content. If, at an iteration of block 362, the system determines that the additional user input was not provided to modify the musical content, then the system returns to block 360. However, it should be noted that the system can still respond to the user if the additional user input was not provided to modify the musical content. Nonetheless, the system can still continue monitoring for additional user inputs that are provided to modify the musical content such that it persists across a dialog session between the user and the system, and such that it persists across multiple dialog sessions between the user and the system.

If, at an iteration of block 362, the system determines that the additional user input was provided to modify the musical content, then the system proceeds to block 364. At block 364, the system determines one or more seeds for the lyrical content and/or the music composition content. For example, the system can determine a seed for the lyrical content and the music composition content (e.g., as described with respect to the lyrical seed engine 171 and the music composition seed engine 172 of FIGS. 1 and 2). Additionally, or alternatively, the system can determine a corresponding seed for the lyrical content and an additional corresponding seed for the music composition content (e.g., as described with respect to the lyrical seed engine 171 and the music composition seed engine 172 of FIGS. 1 and 2). It should be understood that the seed(s) determined at block 364 can vary based on how the additional user input requests that the musical content be modified. The system returns to block 354 and continues with the method 300.

However, in returning to block 354 and continuing with the method 300, the system can process additional GM input to generate additional GM output. The additional GM input includes at least the seed(s) determined at block 364 and the additional user input. Accordingly, by continuing with the iteration of the method 300, and through utilization of the seed(s), a modified version of the musical content should retain aspects of the originally rendered musical content, but also include modifications based on how the additional user input requests that the musical content be modified.

Although the method 300 of FIG. 3 is described with respect to using a single GM to generate the musical content, it should be understood that is one technique contemplated herein and is not meant to be limiting.

Turning now to FIG. 4, a flowchart illustrating an example method 400 of using multiple generative models (GMs) to generate musical content is depicted. For convenience, the operations of the method 400 are described with reference to a system that performs the operations. This system of the method 400 includes one or more processors, memory, and/or other component(s) of computing device(s) (e.g., client device 110 of FIG. 1, generative content system 120 of FIG. 1, computing device 610 of FIG. 6, one or more servers, and/or other computing devices). Moreover, while operations of the method 400 are shown in a particular order, this is not meant to be limiting. One or more operations may be reordered, omitted, and/or added.

At block 452, the system receives user input associated with a client device, the user input including a request for musical content, and the musical content including at least lyrical content and music composition content. The user input can be received via typed input, spoken input, touch input, etc.

At block 454, the system processes, using a first generative model (GM), first GM input to generate first GM output, the first GM input including at least the user input. The first GM can be utilized, for example, to generate the lyrical content. Further, the first GM input can be tailored to the first GM that generates the lyrical content by including, for instance, appropriate context information along with the user input for generating the lyrical content, appropriate dynamic prompt(s) along with the user input for generating the lyrical content, etc. The first GM can be, for example, a large language model (LLM), an audio generation model, etc. The first GM input and processing of the first GM input by the first GM is described in more detail herein (e.g., with respect to the GM input engine 141 and the GM processing engine 142 of FIGS. 1 and 2).

At block 456, the system determines, based on the first GM output, the lyrical content. The first GM output can be, for example, a probability distribution over a sequence of words or word units (e.g., when the first GM is an LLM) or over a sequence of phonemes or phonetic units (e.g., when the first GM is an audio generation model). Based on the probability distribution, the system can determine the lyrical content from the sequence of words or word units or the sequence of phonemes or phoneme units (e.g., as described with respect to the GM output engine 143 of FIGS. 1 and 2).

At block 458, the system processes, using a second GM, second GM input to generate second GM output, the second GM input including at least the user input. The second GM can be utilized, for example, to generate the music composition content. Further, the second GM input can be tailored to the second GM that generates the music composition content by including, for instance, appropriate context information along with the user input for generating the music composition content, appropriate dynamic prompt(s) along with the user input for generating the music composition content, etc. The second GM can be, for example, another large language model (LLM) and/or another audio generation model (e.g., AudioLM), etc. The second GM input and processing of the second GM input by the second GM is described in more detail herein (e.g., with respect to the GM input engine 141 and the GM processing engine 142 of FIGS. 1 and 2).

At block 460, the system determines, based on the second GM output, the music composition content. The second GM output can be, for example, a probability distribution over a sequence of musical notes or musical note units. Based on the probability distribution, the system can determine the music composition content from the sequence of musical notes or musical note units (e.g., as described with respect to the GM output engine 143 of FIGS. 1 and 2).

At block 462, the system causes the musical content to be rendered at the client device. In some implementations, the system can cause the lyrical content to be visually rendered at a display of the client device. In additional or alternative implementations, the system can cause the lyrical content to be audibly rendered via speaker(s) of the client device. In some implementations, the system can cause the music composition content to be audibly rendered via the speaker(s) of the client device, and optionally along with the lyrical content. In additional or alternative implementations, the system can cause a selectable element or link to be rendered via a display of the client device and that, when selected, causes the music composition content to be audibly rendered via the speaker(s) of the client device.

At block 464, the system determines whether additional user input has been received. The additional user input can be received via typed input, spoken input, touch input, etc. If, at an iteration of block 464, the system determines that no additional user input has been received, then the system can continue monitoring for additional user input at block 464.

If, at an iteration of block 464, the system determines that no additional user input has been received, then the system proceeds to block 466. At block 466, the system determines whether the additional user input was provided to modify the musical content.

If, at an iteration of block 466, the system determines that the additional user input was not provided to modify the musical content, then the system returns to block 464. However, it should be noted that the system can still respond to the user if the additional user input was not provided to modify the musical content. Nonetheless, the system can still continue monitoring for additional user inputs that are provided to modify the musical content such that it persists across a dialog session between the user and the system, and such that it persists across multiple dialog sessions between the user and the system.

If, at an iteration of block 466, the system determines that the additional user input was provided to modify the musical content, then the system proceeds to block 468. At block 468, the system determines one or more seeds for the lyrical content and/or the music composition content. For example, the system can determine a seed for the lyrical content and the music composition content (e.g., as described with respect to the lyrical seed engine 171 and the music composition seed engine 172 of FIGS. 1 and 2). Additionally, or alternatively, the system can determine a corresponding seed for the lyrical content and an additional corresponding seed for the music composition content (e.g., as described with respect to the lyrical seed engine 171 and the music composition seed engine 172 of FIGS. 1 and 2). It should be understood that the seed(s) determined at block 468 can vary based on how the additional user input requests that the musical content be modified. The system returns to block 454 and continues with the method 400.

However, in returning to block 454 and continuing with the method 400, the system can process additional GM inputs to generate additional GM outputs. The additional GM inputs includes at least the seed(s) determined at block 468 and the additional user input. Accordingly, by continuing with the iteration of the method 400, and through utilization of the seed(s), a modified version of the musical content should retain aspects of the originally rendered musical content, but also include modifications based on how the additional user input requests that the musical content be modified.

Although the method 400 of FIG. 4 does not include counterparts to be various sub-blocks described with respect to the method 300 of FIG. 3, it should be understood that is for the sake of brevity and is not meant to be limiting. For example, in some implementations, and although not depicted in the method 400 of FIG. 4, the system can determine visual multimedia content to be rendered at the client device while the musical content is being rendered at the client device. The visual multimedia content can include, for example, generative visual multimedia content and/or non-generative visual multimedia content. In implementations where the visual multimedia content includes generative visual multimedia content, the system can determine the generative visual multimedia content based on one or more of the probability distributions over one or more of the sequences of tokens from the first GM or the second GM (e.g., as described with respect to the GM output engine 143 of FIGS. 1 and 2). In additional or alternative implementations, where the visual multimedia content includes generative visual multimedia content, the system can utilize a separate image generation GM or a separate video generation GM that is separate from the first GM and that is also separate from the second GM. In implementations where the visual multimedia content includes non-generative visual multimedia content, the system can obtain the non-generative visual multimedia content from one or more databases that are personal to the user that provided the user input and based on one or more entities referenced in the user input.

As another example, in some implementations, and although not depicted in the method 400 of FIG. 4, the system can cause the lyrical content to be rendered in a voice of the user of the client device. For instance, the lyrical content may correspond to text that is determined based on the first GM output (e.g., when the first GM is an LLM). Accordingly, in synthesizing audio data that captures the lyrical content, the system can utilize a voice embedding of the user (e.g., stored in the user profile database 110A or obtained by requesting the user speak a few sentences during the interaction) and/or a set of one or more prosodic properties associated with the user (e.g., stored in the user profile database 110A or obtained by requesting the user speak a few sentences during the interaction) to synthesize the audio data such that it is audibly perceived as being spoken or sung by the user that provided the user input. Also, for instance, the lyrical content may correspond to audio data that is determined based on the first GM output (e.g., when the first GM is an audio generation model). Accordingly, rather than synthesizing audio data that captures the lyrical content, the system can adapt the lyrical content using the voice embedding of the user and/or the set of one or more prosodic properties associated with the user such that it is audibly perceived as being spoken or sung by the user that provided the user input.

Turning now to FIGS. 5A, 5B, 5C, 5D, 5E, and 5F, various non-limiting examples of generating musical content are depicted. A client device 110 (e.g., the client device 110 from FIG. 1) may include various user interface components including, for example, microphone(s) to generate audio data based on spoken utterances and/or other audible input, speaker(s) to audibly render synthesized speech and/or other audible output, and/or a display 191 to visually render visual output. Further, the display 191 of the client device 110 can include various system interface elements 192, 193, and 194 (e.g., hardware and/or software interface elements) that may be interacted with by a user of the client device 110 to cause the client device 110 to perform one or more actions. The display 191 of the client device 110 enables the user to interact with content rendered on the display 191 by touch input (e.g., by directing user input to the display 191 or portions thereof (e.g., to a text entry box 195, to a keyboard (not depicted), or to other portions of the display 191)) and/or by spoken input (e.g., by selecting microphone interface element 196—or just by speaking without necessarily selecting the microphone interface element 196 (i.e., an automated assistant may monitor for one or more terms or phrases, gesture(s) gaze(s), mouth movement(s), lip movement(s), and/or other conditions to activate spoken input) at the client device 110). Although the client device 110 depicted in FIGS. 5A, 5B, 5C, 5D, 5E, and 5F is a mobile phone, it should be understood that is for the sake of example and is not meant to be limiting. For example, the client device 110 may be a standalone speaker with a display, a standalone speaker without a display, a home automation device, an in-vehicle system, a laptop, a desktop computer, and/or any other device capable of executing an automated assistant to engage in a human-to-computer dialog session with the user of the client device 110.

Referring specifically to FIG. 5A, assume that a user of the client device 110 accesses a generative content application, via the client device 110, that enables the user to interact with a generative content system (e.g., the generative content system 120 of FIG. 1). Further assume that the user provides user input 552A of “Help me write a lullaby for Frank that reminds him daddy loves him”. In response to receiving the user input 552A, the generative content system can generate musical content (e.g., as described with respect to the method 300 FIG. 3 or the method 400 of FIG. 4). The musical content can include lyrical content as indicated at 554A1 and music composition content as indicated at 554A2. Notably, the lyrical content can be visually and/or audibly rendered via speaker(s) of the client device 110. Further, the music composition content can be audibly rendered via the speaker(s) of the client device 110. However, in various implementations, the lyrical content and/or the music composition content may not be audibly rendered until additional user input is provided to cause the lyrical content and/or the music composition to be audibly rendered.

Referring specifically to FIG. 5B, and continuing with the example from FIG. 5A, further assume that the user provides additional user input 552B of “Frank also loves planes and cats, can you include these in the lyrics as well?”. In response to receiving the additional user input 552B, the generative content system can determine seed(s) for the lyrical content and/or the music composition content that was originally rendered in FIG. 5A and as indicated at 554B1. Notably, in the example of FIG. 5B, the additional user input 552B is not requesting that any of the music composition content be modified. However, the additional user input 552B is requesting that the lyrical content be modified. In particular, the additional user input 552B is requesting that the lyrical content be supplemented to include lyrical content related to planes and cats. Accordingly, in subsequently processing the seed(s) along with the additional user input, the generative content system ensures that the lyrical content and the music composition content is substantially similar to the lyrical content and the music composition content that was originally rendered in FIG. 5A, but the lyrical content includes additional lyrics related to planes and cats as indicated at 554B2 and the music composition content is unchanged as indicated at 554A2 in FIG. 5B.

Referring specifically to FIG. 5C, and continuing with the example from FIGS. 5A and 5B, further assume that the user provides additional user input 552C of “The lyrics are perfect, can you make the music a bit more rocky?”. In response to receiving the additional user input 552C, the generative content system can determine seed(s) for the lyrical content and/or the music composition content that was subsequently rendered in FIG. 5B and as indicated at 554C1. Notably, in the example of FIG. 5C, the additional user input 552C is not requesting that any of the lyrical content be modified. However, the additional user input 552C is requesting that the music composition be modified. In particular, the additional user input 552C is requesting that the music composition content reflect the genre of rock music. Accordingly, in subsequently processing the seed(s) along with the additional user input, the generative content system ensures that the lyrical content and the music composition content is substantially similar to the lyrical content and the music composition content that was subsequently rendered in FIG. 5B, but the music composition content includes more elements represented by the genre of rock music as indicated at 554C3 and the lyrical content is unchanged as indicated at 554B2 in FIG. 5C.

Referring specifically to FIG. 5D, and continuing with the example from FIGS. 5A-5C, further assume that the user provides additional user input 552D of “Can you add some images of planes and cats to go along with the lullaby as well?”. In response to receiving the additional user input 552D, the generative content system can call an image generation model (e.g., the same model that was utilized to generate the lyrical content and/or the music composition content, and/or a separate image generation model) as indicated at 554D1. For instance, the generative content system can generate prompt(s) that, when processed by the image generation model, cause generative image(s) of plane(s) and generative image(s) of cat(s) to be rendered at the client device 110 as indicated by 554D2 and 554D3, respectively. Although the example of FIG. 5D is described with respect to the generative content system causing generative image(s) of plane(s) and cat(s) to be generated and rendered, it should be understood that is for the sake of example and is not meant to be limiting. Rather, it should be understood that non-generative image(s) of plane(s) and/or cat(s) can be obtained (e.g., via a call to an image search system or the like via the external system(s) 190). Notably, these generative image(s) can be rendered while the musical content is being played back at the client device 110.

Referring specifically to FIG. 5E, and continuing with the example from FIGS. 5A-5D, further assume that the user provides additional user input 552E of “Can you add some images of me and Frank as well?”. In response to receiving the additional user input 552E, the generative content system can access and obtain image(s) of the user and Frank as indicated at 554E1. For instance, the generative content system can access a photo album of the user (or cause an automated assistant to access the photo album of the user) to obtain, for example, first image(s) of the user and Frank as indicated at 554E2, second image(s) of the user and Frank as indicated at 554E3, and/or other image(s) and/or video(s) of the user and Frank. Notably, these non-generative image(s) can be rendered while the musical content is being played back at the client device 110.

Referring specifically to FIG. 5F, and continuing with the example from FIGS. 5A-5E, further assume that the user provides additional user input 552F of “Perfect, let's hear the lullaby and use my voice to sing the lyrics”. In response to receiving the additional user input 552F, the generative content system can synthesize and/or adapt the lyrical content to be audibly rendered in a voice of the user of the client device 110. Accordingly, in playing back the lullaby for presentation to the user of the client device 110 as indicated at 554F1, the generative content system can audibly render the modified version of the lyrical content from FIG. 5B and in the voice of the user as requested in FIG. 5F as indicated by 554F2. Further, the generative content system can audibly render the modified version of the music composition content from FIG. 5C as indicated by 554F3. Moreover, the generative content system can visually render the generative and non-generative image(s) requested in FIGS. 5D and 5E as indicated by 554F4. The user can continue interacting with the generative content as desired.

Although FIGS. 5A-5F are described with respect to particular examples, it should be understood that those examples are provided to illustrate techniques contemplated herein and are not meant to be limiting. Further, although a transcript of the interaction is depicted throughout FIGS. 5A-5F, it should be understood that is for the sake of example and is not meant to be limiting.

Turning now to FIG. 6, a block diagram of an example computing device 610 that may optionally be utilized to perform one or more aspects of techniques described herein is depicted. In some implementations, one or more of a client device, multi-modal response system component(s) or other cloud-based software application component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIGS. 1 and 2.

These software modules are generally executed by processor 614 alone or in combination with other processors. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, and includes: receiving user input associated with a client device of a user, the user input including a request for musical content, and the musical content including lyrical content and music composition content; and generating the musical content that is responsive to the user input. Generating the musical content that is responsive to the user input includes: processing, using a generative model (GM), GM input to generate GM output, the GM input including at least the user input; and determining, based on the GM output, the lyrical content and the music composition content. The method further includes causing the musical content to be audibly rendered at the client device.

These and other implementations of technology disclosed herein can optionally include one or more of the following features.

In some implementations, the method further includes receiving additional user input associated with the client device of the user, the additional user input including a request to modify the lyrical content and/or the music composition content; generating a modified version of the musical content that is responsive to the additional user input, the modified version of the musical content including a modified version of the lyrical content and/or a modified version of the music composition content; and causing the modified version of the musical content to be audibly rendered at the client device.

In some versions of those implementations, generating the modified version of the musical content that is responsive to the additional user input may include: processing, using the GM, additional GM input to generate additional GM output, the additional GM input including at least the additional user input and one or more seeds associated with the musical content; and determining, based on the additional GM output, the modified version of the lyrical content and/or the modified version of the music composition content.

In some further versions of those implementations, each of the one or more seeds associated with the musical content may be a corresponding lower-level representation of the lyrical content and/or the music composition content.

In some yet further versions of those implementations, the corresponding lower-level representation of the lyrical content and/or the music composition content may be a corresponding embedding in an embedding space.

In some implementations, the method may further include: determining visual multimedia content to be visually rendered at the client device while the musical content is being audibly rendered at the client device; and causing the visual multimedia content to be visually rendered via a display of the client device while the musical content is being audibly rendered at the client device.

In some versions of those implementations, the visual multimedia content may be generative visual multimedia content.

In some further versions of those implementations, determining the visual multimedia content to be visually rendered at the client device while the musical content is being audibly rendered at the client device may include: determining, based on the GM output, the generative visual multimedia content.

In some yet further versions of those implementations, the generative visual multimedia content may be synchronized with the musical content.

In additional or alternative further versions of those implementations, determining the visual multimedia content to be visually rendered at the client device while the musical content is being audibly rendered at the client device may include: processing, using an image GM, image GM input to generate image GM output, the image GM input including at least the user input; and determining, based on the image GM output, the generative visual multimedia content.

In some yet further versions of those implementations, the method may further include, prior to causing the visual multimedia content to be visually rendered at the client device while the musical content is being audibly rendered at the client device: synchronizing the generative visual multimedia content with the musical content.

In additional or alternative further versions of those implementations, the image GM input may further include the lyrical content and/or the musical composition content.

In additional or alternative versions of those implementations, the visual multimedia content may be non-generative visual multimedia content.

In some further versions of those implementations, determining the visual multimedia content to be visually rendered at the client device while the musical content is being audibly rendered at the client device may include: identifying one or more entities included in the request for the musical content; and causing, based on one or more of the entities included in the request for the musical content, the non-generative visual multimedia content to be obtained.

In some yet further versions of those implementations, the method may further include, prior to causing the visual multimedia content to be visually rendered at the client device while the musical content is being audibly rendered at the client device: synchronizing the non-generative visual multimedia content with the musical content.

In even some yet further versions of those implementations, the non-generative visual multimedia content may be obtained from a visual multimedia content database that is personal to the user of the client device.

In some implementations, causing the musical content to be audibly rendered at the client device may include: causing the lyrical content to be audibly rendered via one or more speakers of the client device; and simultaneously causing the music composition content to be audibly rendered via the one or more speakers of the client device.

In some versions of those implementations, the lyrical content may be audibly rendered in a voice of the user of the client device.

In some yet further versions of those implementations, the lyrical content determined based on the GM output may be text corresponding to the lyrical content, and the lyrical content that is audibly rendered via the one or more speakers of the client device may include synthesized speech audio data capturing the lyrical content.

In some even yet further versions of those implementations, the method may further include: causing the lyrical content and a representation of the voice of the user of the client device to be processed, using a text-to-speech (TTS) model, to generate the lyrical content in the voice of the user of the client device.

In some even yet further versions of those implementations, the representation of the voice of the user of the client device may include one or more of: a voice embedding of the user of the client device, or prosodic properties for the voice of the user of the client device.

In some implementations, the GM output may include at least a first probability distribution over a first sequence of tokens and a second probability distribution over a second sequence of tokens.

In some versions of those implementations, the first sequence of tokens may be a sequence of words or word units or a sequence of phonemes or phonetic units, and determining the lyrical content based on the GM output may include: determining, based on the first probability distribution, the lyrical content from the sequence of words or word units or the sequence of phonemes or phonetic units.

In additional or alternative versions of those implementations, the second sequence of tokens may be a sequence of musical notes or musical note units, and determining the music composition content based on the GM output may include: determining, based on the second probability distribution, the music composition content from the sequence of musical notes or musical note units.

In some implementations, the method may further include, prior to receiving the user input associated with the client device of the user: fine-tuning the GM to generate the GM output based on which the lyrical content and the music composition content is determined.

In some versions of those implementations, fine-tuning the GM may include: obtaining a plurality of first fine-tuning instances, each of the plurality of first fine-tuning instances including a corresponding fine-tuning user input and corresponding fine-tuning lyrical content; and fine-tuning, based on the plurality of first fine-tuning instances, the GM.

In some versions of those implementations, fine-tuning the GM may further include: obtaining a plurality of second fine-tuning instances, each of the plurality of second fine-tuning instances including a corresponding fine-tuning user input and corresponding fine-tuning music composition content; and fine-tuning, based on the plurality of second fine-tuning instances, the GM.

In some implementations, the method may further include, prior to causing the musical content to be audibly rendered at the client device: causing the lyrical content to be visually rendered via a display of the client device; and determining whether user confirmation is received to cause the musical content to be audibly rendered at the client device. Causing the musical content to be audibly rendered at the client device is in response to determining that the user confirmation to cause the musical content to be audibly rendered at the client device has been received.

In some versions of those implementations, the method may further include, in response to determining that the user confirmation to cause the musical content to be audibly rendered at the client device has not been received: refraining from causing the musical content to be audibly rendered at the client device.

In some implementations, a method implemented by one or more processors is provided, and includes: receiving user input associated with a client device of a user, the user input including a request for musical content, the musical content including lyrical content and music composition content; and generating the musical content that is responsive to the user input. Generating the musical content that is responsive to the user input comprises: processing, using a first generative model (GM), first GM input to generate first GM output, the first GM input including at least the user input; determining, based on the first GM output, the lyrical content; processing, using a second generative model (GM), second GM input to generate second GM output, the second GM input including at least the user input; and determining, based on the second GM output, the music composition content. The method further includes causing the lyrical content and the music composition content to be audibly rendered at the client device.

These and other implementations of technology disclosed herein can optionally include one or more of the following features.

In some implementations, the method may further include: receiving additional user input associated with the client device of the user, the additional user input including a request to modify the lyrical content and/or the music composition content; generating a modified version of the musical content that is responsive to the additional user input, the modified version of the musical content including a modified version of the lyrical content and/or a modified version of the music composition content; and causing the modified version of the musical content to be audibly rendered at the client device.

In some versions of those implementations, generating the modified version of the musical content that is responsive to the additional user input may include: determining whether the request included in the additional user input is a request to modify the lyrical content and/or a request to modify the music composition content; in response to determining that the request included in the additional user input is a request to modify the lyrical content: processing, using the first GM, additional first GM input to generate additional first GM output, the additional first GM input including at least the additional user input and one or more seeds associated with the lyrical content; and determining, based on the additional first GM output, the modified version of the lyrical content; and in response to determining that the request included in the additional user input is a request to modify the music composition content: processing, using the second GM, additional second GM input to generate additional second GM output, the additional second GM input including at least the additional user input and one or more seeds associated with the music composition content; and determining, based on the additional second GM output, the modified version of the music composition content.

In some further versions of those implementations, the method further includes, in response to determining that the request included in the additional user input is not a request to modify the lyrical content: refraining from any further processing using the first GM; and in response to determining that the request included in the additional user input is not a request to modify the music composition content refraining from any further processing using the second GM.

In additional or alternative further versions of those implementations, each of the one or more seeds associated with the lyrical content may be a corresponding lower-level representation of the lyrical content.

In additional or alternative further versions of those implementations, each of the one or more seeds associated with the music composition content may be a corresponding lower-level representation of the music composition content.

In some implementations, the method may further include: determining visual multimedia content to be visually rendered at the client device while the musical content is being audibly rendered at the client device; and causing the visual multimedia content to be visually rendered via a display of the client device while the musical content is being audibly rendered at the client device.

In some versions of those implementations, the visual multimedia content may be generative visual multimedia content.

In some further versions of those implementations, determining the visual multimedia content to be visually rendered at the client device while the musical content is being audibly rendered at the client device may include: determining, based on the first GM output or the second GM output, the generative visual multimedia content.

In some yet further versions of those implementations, the generative visual multimedia content may be synchronized with the musical content.

In additional or alternative further versions of those implementations, determining the visual multimedia content to be visually rendered at the client device while the musical content is being audibly rendered at the client device may include: processing, using an image GM that is in addition to the first GM and that is in addition to the second GM, image GM input to generate image GM output, the image GM input including at least the user input; and determining, based on the image GM output, the generative visual multimedia content.

In some yet further versions of those implementations, the method may further include, prior to causing the visual multimedia content to be visually rendered at the client device while the musical content is being audibly rendered at the client device: synchronizing the generative visual multimedia content with the musical content.

In additional or alternative further versions of those implementations, the image GM input may further includes the lyrical content and/or the musical composition content.

In additional or alternative versions of those implementations, the visual multimedia content may be non-generative visual multimedia content.

In some further versions of those implementations, determining the visual multimedia content to be visually rendered at the client device while the musical content is being audibly rendered at the client device may include: identifying one or more entities included in the request for the musical content; and causing, based on one or more of the entities included in the request for the musical content, the non-generative visual multimedia content to be obtained.

In some yet further versions of those implementations, the methos may further include, prior to causing the visual multimedia content to be visually rendered at the client device while the musical content is being audibly rendered at the client device: synchronizing the non-generative visual multimedia content with the musical content.

In additional or alternative yet further versions of those implementations, the non-generative visual multimedia content may be obtained from a visual multimedia content database that is personal to the user of the client device.

In some implementations, causing the musical content to be audibly rendered at the client device may include: causing the lyrical content to be audibly rendered via one or more speakers of the client device; and simultaneously causing the music composition content to be audibly rendered via the one or more speakers of the client device.

In some even yet further versions of those implementations, the lyrical content may be audibly rendered in a voice of the user of the client device.

In some even yet further versions of those implementations, the lyrical content determined based on the first GM output may be text corresponding to the lyrical content, and the lyrical content that is audibly rendered via the one or more speakers of the client device may include synthesized speech audio data capturing the lyrical content.

In some even yet further versions of those implementations, the method may further include causing the lyrical content and a representation of the voice of the user of the client device to be processed, using a text-to-speech (TTS) model, to generate the lyrical content in the voice of the user of the client device.

In some even yet further versions of those implementations, the representation of the voice of the user of the client device may include one or more of: a voice embedding of the user of the client device, or prosodic properties for the voice of the user of the client device.

In some implementations, the first GM output may include at least a first probability distribution over a first sequence of tokens, and the second GM output may include a second probability distribution over a second sequence of tokens.

In some versions of those implementations, the first sequence of tokens may be a sequence of words or word units, and determining the lyrical content based on the first GM output may include: determining, based on the first probability distribution, the lyrical content from the sequence of words or word units.

In additional or alternative versions of those implementations, the second sequence of tokens may be a sequence of musical notes or musical note units, and determining the music composition content based on the second GM output may include: determining, based on the second probability distribution, the music composition content from the sequence of musical notes or musical note units.

In some implementations, the method may further include, prior to receiving the user input associated with the client device of the user: fine-tuning the first GM to generate the first GM output based on which the lyrical content is determined; and fine-tuning the second GM to generate the second GM output based on which the music composition content is determined.

In some further versions of those implementations, fine-tuning the first GM may include: obtaining a plurality of first fine-tuning instances, each of the plurality of first fine-tuning instances including a corresponding fine-tuning user input and corresponding fine-tuning lyrical content; and fine-tuning, based on the plurality of first fine-tuning instances, the first GM.

In additional or alternative versions of those implementations, fine-tuning the second GM comprises: obtaining a plurality of second fine-tuning instances, each of the plurality of second fine-tuning instances including a corresponding fine-tuning user input and corresponding fine-tuning music composition content; and fine-tuning, based on the plurality of second fine-tuning instances, the second GM.

In some implementations, the method may further include, prior to causing the musical content to be audibly rendered at the client device: causing the lyrical content to be visually rendered via a display of the client device; and determining whether user confirmation is received to cause the musical content to be audibly rendered at the client device. Causing the musical content to be audibly rendered at the client device may be in response to determining that the user confirmation to cause the musical content to be audibly rendered at the client device has been received.

In some further versions of those implementations, the method may further include, in response to determining that the user confirmation to cause the musical content to be audibly rendered at the client device has not been received: refraining from causing the musical content to be audibly rendered at the client device.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods. Some implementations also include a computer program product including instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
receiving user input associated with a client device of a user, the user input including a request for musical content, and the musical content including lyrical content and music composition content;
generating the musical content that is responsive to the user input, wherein generating the musical content that is responsive to the user input comprises:
processing, using a generative model (GM), GM input to generate GM output, the GM input including at least the user input; and
determining, based on the GM output, the lyrical content and the music composition content; and
causing the musical content to be audibly rendered at the client device.

2. The method of claim 1, further comprising:
receiving additional user input associated with the client device of the user, the additional user input including a request to modify the lyrical content and/or the music composition content;
generating a modified version of the musical content that is responsive to the additional user input, the modified version of the musical content including a modified version of the lyrical content and/or a modified version of the music composition content; and
causing the modified version of the musical content to be audibly rendered at the client device.

3. The method of claim 2, wherein generating the modified version of the musical content that is responsive to the additional user input comprises:
processing, using the GM, additional GM input to generate additional GM output, the additional GM input including at least the additional user input and one or more seeds associated with the musical content; and
determining, based on the additional GM output, the modified version of the lyrical content and/or the modified version of the music composition content.

4. The method of claim 3, wherein each of the one or more seeds associated with the musical content is a corresponding lower-level representation of the lyrical content and/or the music composition content.

5. The method of claim 4, wherein the corresponding lower-level representation of the lyrical content and/or the music composition content is a corresponding embedding in an embedding space.

6. The method of claim 1, further comprising:
determining visual multimedia content to be visually rendered at the client device while the musical content is being audibly rendered at the client device; and
causing the visual multimedia content to be visually rendered via a display of the client device while the musical content is being audibly rendered at the client device.

7. The method of claim 6, wherein the visual multimedia content is generative visual multimedia content.

8. The method of claim 7, wherein determining the visual multimedia content to be visually rendered at the client device while the musical content is being audibly rendered at the client device comprises:
determining, based on the GM output, the generative visual multimedia content.

9. The method of claim 8, wherein the generative visual multimedia content is synchronized with the musical content.

10. The method of claim 7, wherein determining the visual multimedia content to be visually rendered at the client device while the musical content is being audibly rendered at the client device comprises:
processing, using an image GM, image GM input to generate image GM output, the image GM input including at least the user input; and
determining, based on the image GM output, the generative visual multimedia content.

11. The method of claim 10, wherein the image GM input further includes the lyrical content and/or the musical composition content.

12. The method of claim 6, wherein the visual multimedia content is non-generative visual multimedia content.

13. The method of claim 12, wherein determining the visual multimedia content to be visually rendered at the client device while the musical content is being audibly rendered at the client device comprises:
identifying one or more entities included in the request for the musical content; and
causing, based on one or more of the entities included in the request for the musical content, the non-generative visual multimedia content to be obtained.

14. The method of claim 13, further comprising:
prior to causing the visual multimedia content to be visually rendered at the client device while the musical content is being audibly rendered at the client device:
synchronizing the non-generative visual multimedia content with the musical content.

15. The method of claim 13, wherein the non-generative visual multimedia content is obtained from a visual multimedia content database that is personal to the user of the client device.

16. The method of claim 1, wherein causing the musical content to be audibly rendered at the client device comprises:
causing the lyrical content to be audibly rendered via one or more speakers of the client device; and
simultaneously causing the music composition content to be audibly rendered via the one or more speakers of the client device.

17. The method of claim 16, wherein the lyrical content is audibly rendered in a voice of the user of the client device.

18. A system comprising:
at least one processor; and
memory storing instructions that, when executed by the at least one processor, cause the at least one processor to be operable to:
receive user input associated with a client device of a user, the user input including a request for musical content, and the musical content including lyrical content and music composition content;
generate the musical content that is responsive to the user input, wherein the instructions to generate the musical content that is responsive to the user input comprise instructions to:
process, using a generative model (GM), GM input to generate GM output, the GM input including at least the user input; and
determine, based on the GM output, the lyrical content and the music composition content; and
cause the musical content to be audibly rendered at the client device.

19. A non-transitory computer-readable storage medium storing instructions that, when executed by at least one processor, cause the at least one processor to be operable to perform operations, the operations comprising:
receiving user input associated with a client device of a user, the user input including a request for musical content, and the musical content including lyrical content and music composition content;
generating the musical content that is responsive to the user input, wherein generating the musical content that is responsive to the user input comprises:
processing, using a generative model (GM), GM input to generate GM output, the GM input including at least the user input; and
determining, based on the GM output, the lyrical content and the music composition content; and
causing the musical content to be audibly rendered at the client device.
